(19) United States
(12) Patent Application Publication
(10) Pub. No.: US 2009/0135268 A1
(43) Pub. Date: May 28, 2009

(54) FORMAT AUTO-SET SYSTEM USED IN IMAGING DEVICE

(75) Inventor: CHANG-CHIANG LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/057,691

(22) Filed: Mar. 28, 2008

(30) Foreign Application Priority Data
Nov. 27, 2007 (CN) 200710202727.8

(51) Int. Cl. H04N 5/228

(52) U.S. Cl. 348/222.1

(57) ABSTRACT

A format auto-set system for setting an output format of the imaging device includes a connecting module for connecting the imaging device to a display device having a screen, a processing module for outputting an image from the imaging device to the display device via the connecting module in a first output format and a second output format, an image capturing module for capturing images displayed on the screen of the display device, a judging module for determining which image displayed on the screen most resembles the image output from the imaging device and generating a setting signal, and a setting module for receiving the setting signal, and setting an output format of the imaging device as the first output format or the second output format to comply with a predetermined format of the display device according to the setting signal.

### BACKGROUND

1. Field of the Invention

The present invention relates to a format auto-set system used in an imaging device.

2. Description of Related Art

Generally, an imaging device, such as a digital still camera (DSC), is capable of outputting images to a display device, such as a television (TV). There are two main formats in TV technology, a National TV System Committee (NTSC) format and a Phase Alteration Line (PAL) format. Correspondingly, the DSC has both the NTSC format and PAL format built therein. To display an image from the DSC on the TV correctly, a predetermined format of such image output from the DSC must comply with a predetermined format of the TV. If the format of the output image of the DSC is different from the predetermined format of the TV, the output image can't be displayed correctly, or can't even be displayed. Generally, the NTSC format is used in the USA, Japan, etc., while the PAL format is used in China, Germany, etc. A TV bought in China cannot correctly display an image output from a DSC bought in the USA, without switching the format of the DSC. This is confusing for people who do not know about the different formats.

What is needed, therefore, is to provide a format auto-set system that can be used in the imaging device, in which the above problems are eliminated or at least alleviated.

### SUMMARY

The present invention relates to a format auto-set system for setting an output format of the imaging device. The format auto-set system includes a connecting module, a processing module, an image capturing module, a judging module, and a setting module. The connecting module is configured for connecting the imaging device to a display device having a screen. The processing module is configured for outputting an image from the imaging device to the display device via the connecting module in a first output format and a second output format. The image capturing module is configured for capturing images displayed on the screen of the display device. The judging module is configured for determining which image displayed on the screen most resembles the image output from the imaging device and generating a setting signal. The setting module is configured for receiving the setting signal, and setting the output format of the imaging device to be the first output format or the second output format to comply with a predetermined format of the display device according to the setting signal.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 shows functional modules of a format auto-set system for connecting an imaging device to a TV according to an exemplary embodiment; and

FIG. 2 shows an image divided into nine areas during a working process of the format auto-set system of FIG. 1.

### DETAILED DESCRIPTION OF THE EMBODIMENTS

Reference will now be made to the figures to describe an exemplary embodiment in detail.

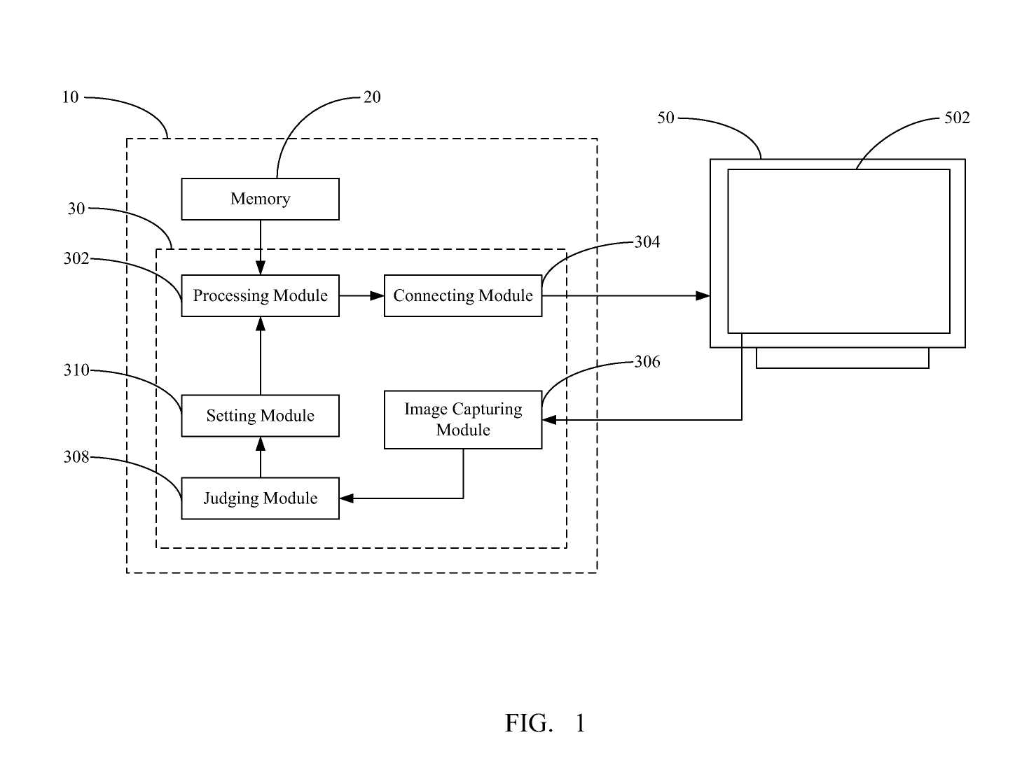

Referring to FIG. 1, a format auto-set system 30 used in an imaging device, such as a DSC 10, is shown. The format auto-set system 30 is connected and outputs images to a display device such as a TV 50. The format auto-set system 30 includes a processing module 302, a connecting module 304, an image capturing module 306, a judging module 308, and a setting module 310. The processing module 302 is configured for outputting an image stored in a memory 20 built in the DSC 10 to the TV 50 via the connecting module 304. For example, the connecting module 304 includes an output terminal (not shown) on the DSC 10, and a cable (not shown). Correspondingly, the TV 50 includes an input terminal (not shown), and the input terminal is connected to the output terminal of the DSC 10 via the cable so that image data can be transmitted from the DSC 10 to the TV 50.

The image capturing module 306 is configured for capturing images, including images displayed on a screen 502 of the TV 50 (hereinafter referred to as “displayed images”). It is to be understood that the image capturing module 306 generally includes an image sensor (not shown), such as a charge coupled device sensor or a complementary metal-oxide semiconductor sensor.

The judging module 308 is configured for determining which displayed image most nearly matches the image output from the DSC 10 (hereinafter referred to as “an output image”). The judging module 308 then outputs a setting signal to the setting module 310.

The setting module 310 is configured for receiving the setting signal from the judging module 308, and setting an output format of the DSC 10 to NTSC or PAL, to comply with a predetermined format of the TV 50 according to the setting signal. Therefore, the output image can be displayed correctly on the screen 502 of the TV 50.

A working process of the format auto-set system 30 is described below. A user presses a function key (not shown) on the DSC 10 to turn on the format auto-set system 30.

The processing module 302 outputs a predetermined image in a first output format, such as a full-green image to the TV 50 having a predetermined format therein. The full-green image is transmitted from the DSC 10 to the TV 50 via the connecting module 304. The image capturing module 306 captures a first displayed image displayed on the screen 502 of the TV 50. After the first displayed image is captured, the processing module 302 outputs the full-green image in a second format to the TV 50 via the connecting module 304. The image capturing module 306 captures a second displayed image displayed on the screen 502 of the TV 50.

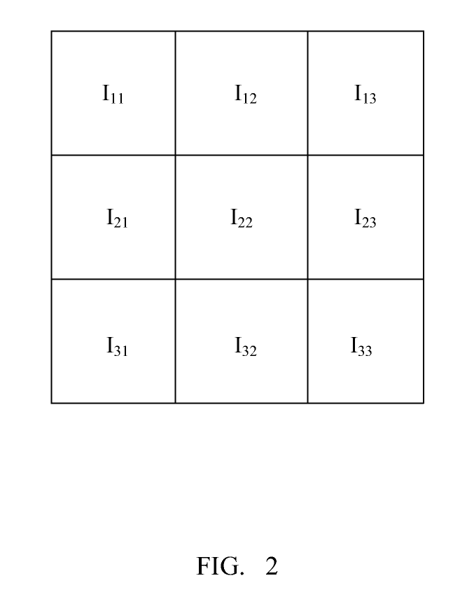

The judging module 308 computes respective green values of the first and second displayed images, and compares the green value of the first displayed image with that of the second displayed image. Referring to FIG. 2, the first displayed image is divided into nine areas, represented as area I₁₁, area I₁₂, area I₁₃, area I₂₁, area I₂₂, area I₂₃, area I₃₁, area I₃₂, area I₃₃ from left to right, and top to bottom of the first displayed image. Referring to table 1, a respective grey value of each of three primary light colors contained in a pixel located on a top left corner of each area of the first displayed image is shown. It is to be understood that alternative locations of the pixel on each area can be selected, but the locations of the pixels on respective areas are the same.

TABLE 1

| | Grey Value | Grey Value of | Grey Value |
|---|---|---|---|
| Area | of Red Light | Green Light | of Blue Light |
| I₁₁ | 42 | 162 | 54 |
| I₁₂ | 57 | 162 | 69 |
| I₁₃ | 46 | 130 | 53 |
| I₂₁ | 42 | 57 | 24 |
| I₂₂ | 37 | 65 | 24 |
| I₂₃ | 39 | 68 | 24 |
| I₃₁ | 38 | 59 | 28 |
| I₃₂ | 41 | 62 | 23 |
| I₃₃ | 40 | 66 | 29 |

Referring to FIG. 2, for all nine areas, respective average grey values Rₐᵥₑ, Gₐᵥₑ, and Bₐᵥₑ of red, green and blue light are 42, 92, and 36. The green value Gᵥ is found using the formula: Gᵥ=Gₐᵥₑ/((Rₐᵥₑ+Bₐᵥₑ)/2). Therefore, the green value Gᵥ of the first displayed image is 2.36. The same way is used to get a green value Gᵥ of the second displayed image, which herein is 1.03. Since a green value of the first displayed image is greater than that of the second displayed image, the judging module 308 determines that the first format of the predetermined image complies with that predetermined format of the TV, and outputs a setting signal to the setting module 310.

The setting module 310 receives the setting signal, and sets an output format of the DSC 10 as the first format, e.g., NTSC or PAL. The format setting is stored in the processing module 302. When the auto-set working process ends, the processing module 302 outputs the images in the memory 20 to the TV 50 according to the set output format.

The above description is an exemplary embodiment to describe how the format auto-set system 30 works. Other color images, such as a full-red image or a full-blue image may be used instead in the format auto-set system 30.

Since a predetermined format of the image output from the DSC 10 to the TV 50 is automatically set according to an image captured from the screen 502 of the TV 50, the system is user friendly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A format auto-set system for setting an output format of the imaging device, the format auto-set system comprising:
a connecting module being configured for connecting the imaging device to a display device having a screen;
a processing module being configured for outputting an image from the imaging device to the display device via the connecting module in a first output format and a second output format;
an image capturing module being configured for capturing images displayed on the screen of the display device;
a judging module being configured for determining which image displayed on the screen most resembles the image output from the imaging device, and generating a setting signal; and
a setting module being configured for receiving the setting signal, and setting an output format of the imaging device as the first output format or the second output format to comply with a predetermined format of the display device according to the setting signal.

2. The format auto-set system as claimed in claim 1, wherein the imaging device is one of a digital still camera, and a camcorder.

3. The format auto-set system as claimed in claim 1, wherein the display device is a television.

4. The format auto-set system as claimed in claim 1, wherein the output format of the imaging device is one of a national television system committee format and a phase alteration line format, and the predetermined format of the display device is one of a national television system committee format and a phase alteration line format.
